(19) United States
(12) Patent Application Publication
(10) Pub. No.: US 2011/0127446 A1
(43) Pub. Date: Jun. 2, 2011

(54) NANOSTRUCTURE SYSTEMS AND METHODS FOR SENSING AN ANALYTE

(76) Inventors: Alexander Star, Pittsburgh, PA (US); Stephane Petoud, Pittsburgh, PA (US); Douglas R. Kauffman, Pittsburgh, PA (US); Chad Michael Shad, Pittsburgh, PA (US); Hyounsoo Uh, Pittsburgh, PA (US)

(21) Appl. No.: 12/784,949

(22) Filed: May 21, 2010

Related U.S. Application Data
(60) Provisional application No. 61/180,214, filed on May 21, 2009.
(60) Provisional application No. 61/251,165, filed on Oct. 13, 2009.

(51) Int. Cl. G01J 1/58; G03C 1/00

(52) U.S. Cl. 250/459.1; 250/458.1; 250/461.1; 252/600

(57) ABSTRACT

A method of detecting an analyte in an environment, includes immobilizing at least one photoactive composition on nanostructures, the photoactive composition exhibiting emission that is sensitive to the analyte; applying electromagnetic radiation to the immobilized photoactive moiety for a period of time; measuring at least one response; and using the measured response to determine the presence the analyte in the environment. The nanostructures can, for example, include carbon nanostructures. In a number of embodiments, the analyte is oxygen.

### CROSS-REFERENCE TO RELATED APPLICATIONS

This application claims benefit of U.S. Provisional Patent Application Ser. No. 61/180,214, filed May 21, 2009 and U.S. Provisional Patent Application Ser. No. 61,251,165, filed Oct. 13, 2009, the disclosures of which are incorporated herein by reference.

### BACKGROUND

The following information is provided to assist the reader to understand the technology described below and certain environments in which such technology can be used. The terms used herein are not intended to be limited to any particular narrow interpretation unless clearly stated otherwise in this document. References set forth herein may facilitate understanding of the technology or the background thereof. The disclosure of all references cited herein are incorporated by reference.

A number or currently available oxygen sensors are based upon an optical measurement of oxygen concentration. In such sensors, a chemical film which has emission (for example, fluorescence, phosphorescence and/or luminescence) properties that depend upon oxygen concentration is immobilized upon a support/probe. In general, after the film is placed in an excited state by application of energy thereto, the emission signal is at a maximum in the absence of oxygen (O₂). O₂ molecules reduce or quench the emission signal. The emission signal is inversely related to the concentration of O₂ in an environment.

Sensors based upon nanotube or other nanostructures for various chemical species are known. However, attempts to develop a nanoelectronic O₂ sensor, have required vacuum conditions and sometimes high temperature.

### SUMMARY

In one aspect, a method of detecting an analyte in an environment, includes: immobilizing at least one photoactive composition on nanostructures, the photoactive composition exhibiting emission that is sensitive to the analyte; applying electromagnetic radiation to the immobilized photoactive moiety for a period of time; measuring at least one response; and using the measured response (for example, during or after application of the electromagnetic energy) to determine the presence the analyte in the environment. The nanostructures can, for example, include carbon nanostructures. In a number of embodiments, the analyte is oxygen.

The measured response can, for example, be at least one of a spectroscopic change or an electrical property change. Each of a spectroscopic change and an electrical property change can, for example, be measured. In a number of embodiments, a change in at least one electrical property of the nanostructures is measured.

The photoactive composition can, for example, include at least one photoactive moiety selected from the group of a naphthalimide, a derivative of a naphthalimide. tropolonate, a derivative of tropolonate, perylene, a derivative of perylene, salophen, a derivative of salophen, anthraquinone, a derivative of anthraquinone, fluorene, a derivative of fluorene, benzimidazole a derivative of benzimidazole, benzimidazole-pyridine, a derivative of benzimidazole-pyridine, salicylamide, derivative of salicylamide, 2-hydroxyisophthalimidem, a derivative of 2-hydroxyisophthalimidem, beta-diketone, a derivative of beta-diketone, pyridine, a derivative of pyridine, bipyridine, a derivative of bypyridine, terpyridine, a derivative of terpyridine, phenanthridine, a derivative of phenanthridine, quinoline. a derivatives of quinoline, a phenol, a derivative of a phenol, and bis(oxazolinyl)pyridine, a derivative of bis(oxazolinyl)pyridine.

The photoactive composition can, for example, include at least one of a lanthanide cation chelated with a photoactive ligand, a transition metal complex, a conjugated polymer (that is, an electroactive or photoactive conjugated polymer), or photoactive inorganic nanoparticles. In the case of a lanthanide cation chelated with a photoactive ligand, the lanthanide cation can, for example, be a cation of Lanthanum (La), Cerium (Ce), Praseodymium (Pr), Neodymium (Nd), Promethium (Pm), Samarium (Sm), Europium (Eu), Gadolinium (Gd), Terbium (Tb), Dysprosium (Dy), Holmium (Ho), Erbium (Er), Thulium, (TM), Ytterbium (Yb), or Lutetium (Lu).

The photoactive moiety can, for example, be incorporated within an oligomer or a polymer. In a number of embodiments, the photoactive moiety is incorporated within an oligomer or a polymer, and the oligomer or the polymer includes oxygen donor atoms or oxygen donor groups.

The nanostructures can, for example, be supported upon a surface or a substrate. The surface can, for example, include SiO₂ or a polymer. The surface can, for example, translucent.

The method can also include measuring at least one electrical property of nanostructures including no photoactive composition immobilized thereon in the environment to provide a reference measurement.

In another aspect, a system for detecting an analyte in an environment, includes: nanostructures including at least one photoactive composition immobilized on the nanostructures, the photoactive composition exhibiting emission that is sensitive to an analyte; at least one energy source to apply electromagnetic radiation to the immobilized photoactive moiety for a period of time; and at least one measurement system (for example, a sensor) to measure a response, the measured response being used to determine the presence the analyte in the environment.

The system can, for example, include at least one measurement system to measure a spectroscopic change and/or at least one measurement system to measure a change in an electrical property of the nanostructures.

In a further aspect, a composition include nanostructures having immobilized thereon a photoactive composition comprising at least one photoactive moiety and at least one lanthanide cation. The photoactive composition can, for example, include at least lanthanide cation chelated with a photoactive ligand. The lanthanide cation can, for example, be a cation of Lanthanum (La), Cerium (Ce), Praseodymium (Pr), Neodymium (Nd), Promethium (Pm), Samarium (Sm), Europium (Eu), Gadolinium (Gd), Terbium (Tb), Dysprosium (Dy), Holmium (Ho), Erbium (Er), Thulium, (TM), Ytterbium (Yb), or Lutetium (Lu). In a number of embodiments, the cation is Ln³⁺, Pr³⁺, Nd³⁺, Sm³⁺, Eu³⁺, Tb³⁺, Dy³⁺, Ho³⁺, Er³⁺, Tm³⁺ or Yb³⁺. In a number of embodiments, the photoactive moiety is incorporated within an oligomer or a polymer.

The technology described herein, along with the attributes and attendant advantages thereof, will best be appreciated and understood in view of the following detailed description taken in conjunction with the accompanying drawings.

### BRIEF DESCRIPTION OF THE DRAWINGS

FIG. 1 illustrates a schematic representation of a representative embodiment of an optically transparent or translucent and electrically conductive device including a single walled nanotube or SWNT network decorated with polymer-chromophore-lanthanide layer for spectroscopic and electrical conductance measurements.

FIG. 2A illustrates a chemical structure of a Eu³⁺-containing dendrimer complex (Eu₈) including eight Eu³⁺ cations coordinated inside of a 1,8-naphthalimide terminated, generation-3 poly(amidoamine) (G3-PAMAM) dendrimer core.

FIG. 2B illustrates an expanded view of the Eu₈ structure illustrating the coordination of the Eu³⁺ ions.

FIG. 3A illustrates a study of the solution phase O₂ sensitivity of the Eu₈ complex in a steady state emission spectrum of a Eu₈ solution (in DMF, 1.45×10⁻⁵ M; λ_{excitation}=354 nm) saturated with O₂ and with Ar.

FIG. 3B illustrates the relative emission intensity of the 1,8-naphthalimide (λₑₘᵢₛₛᵢₒₙ=469 nm; hollow square labels) and Eu^{3+ 5}D₀→⁷F₂ (λₑₘᵢₛₛᵢₒₙ=615 nm; solid circular labels) centered emission bands cycled between Ar and O₂ saturation.

FIG. 4A illustrates an emission (λ_{excitation}=354 nm) spectra of a Eu₈-SWNT device before (Initial curve) and after (After UV curve) 30 minutes of illumination with 365 nm light (in flowing Ar) and during one hour of O₂ exposure (Under O₂ curves); wherein the UV and gas exposure times are identical.

FIG. 4B illustrates UV-vis-NIR absorbance spectra of the Eu₈-SWNT device before and after illumination with 365 nm light (in Ar) and during O₂ exposure wherein the first three semiconducting SWNT (labeled S₁₁-S₃₃) and the first metallic SWNT (labeled M₁₁) absorbance bands correspond to the electronic transitions between van Hove singularities in the SWNT valence band (VB) and conduction band (CB), as shown in the partial density of states (DOS) diagram in the inset.

FIG. 4C illustrates network conductance of the Eu₈-SWNT device during 365 nm illumination and sustained “photogenerated ON-state” (in flowing Ar), followed by the introduction of pure O₂ wherein the network conductance was measured simultaneously with the UV-vis-NIR absorption spectra (FIG. 4B).

FIG. 4D illustrates, without limitation to any specific mechanism, a proposed mechanism describing the Eu₈-SWNT O₂ sensitivity in terms of the Eu₈ electronic structure wherein the 1,8-naphthalimide ground and excited singlet (S₀ and S₁), and excited triplet (T₃) states are shown in relation to the Eu³⁺ acceptor level (Eu³⁺-AL), and the block arrow indicates energy donation into the trap states.

FIG. 5A illustrates network conductance of the Eu₈-SWNT device during 200-second gas exposure cycles of pure Ar and increasing O₂ concentrations (in Ar) at 0% RH wherein the dashed lines represent the period of O₂ delivery, the bars represent the delivered O₂ concentration, and the asterisks represent the initiation of brief UV-illumination periods (365 nm light; flowing Ar) that returned the device to a designated ON-state conductance (G_{ON}), and wherein during the first several seconds of UV illumination the device experienced abrupt but temporary decreases in network conductance before increasing towards the photogenerated ON-state conductance.

FIG. 5B illustrates electrical response rate of the Eu₈-SWNT device to increasing O₂ concentrations during a 200 second exposure cycle, wherein the response rate is defined as the change in network conductance (ΔG as measured from G_{ON}) during an O₂ exposure period.

FIG. 5C illustrates simultaneously recorded conductance of a Eu₈-SWNT network and bare SWNT network on a single quartz substrate during illumination with 365 nm UV light (in flowing N₂) and exposure to pure O₂, 10.5% CO₂, 100 ppm NH₃ and 10 ppm NO₂, wherein the bare SWNT device was masked as to eliminate illumination with UV light, and wherein after each UV light exposure the device remained in flowing N₂ for a period of five minutes, and each gas exposure was for a period of five minutes, and further wherein after CO₂, NH₃ and NO₂ exposures the device was exposed again to pure O₂, and the device conductance was returned to its ON-state conductance with UV light.

FIG. 6 displays the relative response of Eu₈-SWNT networks to 365 nm light and O₂ on quartz in a dry environment and in 43% relative humidity, as well as on hydroxylated (H-quartz) in a dry environment and in 43% RH.

### DETAILED DESCRIPTION

As used herein and in the appended claims, the singular forms “a,” “an”, and “the” include plural references unless the content clearly dictates otherwise. Thus, for example, reference to “a photoactive moiety” includes a plurality of such photoactive moieties and equivalents thereof known to those skilled in the art, and so forth, and reference to “the photoactive moiety” is a reference to one or more such photoactive moieties and equivalents thereof known to those skilled in the art, and so forth.

It is demonstrated herein that electrically conductive nanostructures (for example, single-walled carbon nanotubes or SWNT) or networks decorated with (or having immobilized thereon) a photoactive composition, which can, for example, include chromophoric or photoactive groups or moieties show reversible bimodal (that is, spectroscopic (including absorption and luminescence) and chemiresistor sensitivity) towards an analyte such as oxygen (O₂) gas at room temperature under ambient pressure. The photoactive composition exhibits emission that is sensitive to the analyte. The photoactive composition can for example, include an oligomer or a polymer. The chromophore or photoactive groups or moieties are entities that can be placed in an excited state upon application of electromagnetic radiation or electromagnetic energy (for example, UV light, visible light etc., depending upon the range of wavelength over which the photoactive group is excited) thereto to exhibit detectable photoluminescence.

A number of classes of photoactive compositions are suitable for use herein. For example, lanthanide cations (for example, trivalent lanthanide cations, which are sometimes abbreviated Ln³⁺) chelated with chromophoric ligands to sensitize energy transfer to the lanthanide ion can be used herein. Chromophoric ligands for lanthanides can, for example, be small or relatively low molecular weight molecules or oligomeric or polymeric host systems. Transition metal complexes (for example iridium (III) bis(1-pyrenyl-isoquinolinato-N,C′) acetylacetonate or platinum-tetraphenylporphyrin) are also suitable for use herein. Electroactive and photoactive conjugated polymers such as poly(p-phenylenevinylene) (PPV), poly(p-phenylene) (PPP), polythiophene (PT), polyfluorene (PF) and others also are suitable for user herein. Still further, photoactive inorganic nanoparticles (for example, CdSe, ZnS, InAs, ZnSe, etc) are suitable for user herein.

In the case of trivalent lanthanide cations chelated with chromophoric ligands, complexing one or more chromophores or a composition (for example, an oligomer or polymer) including one or more chromophores or photoactive groups with a lanthanide or lanthanoid ion stabilizes the excited state baseline. The lanthanide or lanthanoid series comprises the fifteen elements with atomic numbers 57 through 71 (including Lanthanum (La), Cerium (Ce), Praseodymium (Pr), Neodymium (Nd), Promethium (Pm), Samarium (Sm), Europium (Eu), Gadolinium (Gd), Terbium (Tb), Dysprosium (Dy), Holmium (Ho), Erbium (Er), Thulium, (TM), Ytterbium (Yb), and Lutetium (Lu). In a number of embodiment, one or more of the following lanthanide cations are used Ln³⁺, Pr³⁺, Nd³⁺, Sm³⁺, Eu³⁺, Tb³⁺, Dy³⁺, Ho³⁺, Er³⁺, Tm³⁺ or Yb³⁺.

In several representative examples, complexes of europium cations (Eu³⁺) were formed with a dendrimer including naphthalimide chromophore groups such as 1,8-naphthalimide chromophore groups and/or derivatives of 1,8-naphthalimide chromophore groups for use in the detection of O₂ (or NOₓ).

However, any electromagnetic radiation/energy absorbing (for example, UV, visible or near-infrared-light absorbing) chromophore or photoactive groups are suitable for use in the present invention. Examples of suitable chromophore groups include, but are not limited to, other members of the naphthalimide family (including for example, 2,3-naphthalimide and 1,2-naphthalimide), 1,8-naphthalimides functionalized at the 4-position with, for example, an amino group, a nitro group, a bromo, an isothiocyanate group or a polyethylene glycol (PEG) group. Such naphthalimides sensitize luminescent lanthanides (emitting, for example, in the visible and in the near-infrared), offering versatility for applications. Still other suitable chromophore groups include, for example, tropolonate and derivatives, perylene and derivatives (for example, perylene dimide), salophen and derivatives, anthraquinone and derivatives, fluorene and derivatives, benzimidazole and derivatives, benzimidazole-pyridine and derivatives, salicylamide and derivatives, 2-hydroxyisophthalimide and derivatives, beta-diketone and derivatives, pyridine and derivatives, bipyridine and derivatives, terpyridine and derivatives, phenanthridine and derivatives, quinoline and derivatives, phenols and derivatives and bis(oxazolinyl)pyridine and derivatives.

The excitation of the photoactive groups immobilized upon the nanostructures changes at least one microelectronic or electrical property of the nanostructures. Likewise, the subsequent effect of the analyte upon the excited state of the photoactive groups (in addition to changing photoemission) changes at least one microelectronic or electrical property of the nanostructures in measurable manner. In that regard, the effect, which is proportional to the concentration of the analyte, can be measured in the form of, for example, resistance, conductance, impedance etc.

Many different oligomers and polymers (including, for example, dendrimers and dendrons) can be used in the present invention to decorate or coat the nanostructures with a polymer-chromophore-lanthanide complexes or other photoactive groups. In general, dendrimers are regular, highly branched polymers that can, for example, have a monodisperse tree-like or generational structure. PAMAM (poly(amidoamine)) dendrimers of any generation are representative examples of suitable oligomers or polymers. In a number of embodiments, polymers and/or oligomers for decorating or coating the nanostructures include oxygen donor atoms/groups for coordination of lanthanides, groups for covalent or other incorporation of photoactive moieties and/or other groups for attachment to the surface of carbon nanotubes. For example, PAMAM oligomers and polymers include internal amide groups capable of binding hard Lewis acid lanthanide ions through their oxygen atoms and include terminal primary amine groups for functionalization with suitable photoactive groups.

As used herein, the term “polymer” refers to a compound including a plurality of repeat or structural units. As known in the art, polymers can be formed via polymerization of one or multiple monomers. The term “oligomer” refers to polymers containing relatively few structural units

In addition to exhibiting an optical (emission quenching) response to the analyte O₂ gas, a linear, electronic response to O₂ gas in concentrations between, for example, 5 and 27% was observed for nanostructures having an immobilized photoactive composition thereon at room temperature and ambient pressure. The bimodal response of such materials can, for example, provide for inherent calibration of sensors including such materials through comparison of the two types of responses. However, each response mode can be used individually and independently to measure analyte/O₂ concentration. For example, measurement of the change of only one or more electrical properties (for example, resistance, conductance, impedance, etc.) can be used to measure the analyte.

Chemically sensitive solid-state resistors (chemiresistors), field effect transistors and emission platforms based on a molecular system with room temperature O₂ gas sensitivity have a broad range of applications to, for example, monitor oxygen levels in enclosed environments or as wearable personal safety devices. In NTFET (nanotube field-effect transistor) devices, one, for example, measures electrical current through carbon nanotubes under an applied gate voltage. In chemiresistor devices, a gate voltage is not applied. In both types of devices, electrical conductance (or resistance) of nanotubes changes upon exposure to chemical analytes, thereby providing a sensor signal. Depending on the semiconducting nature of the nanotubes, application of a gate voltage can provide amplification of the sensor signal. Nanotubes such as single-walled carbon nanotubes (SWNTs) have been heralded as an ideal candidate for incorporation into extremely small and low power devices because they demonstrate extreme environmental sensitivity, high electrical conductivity, and inherent compatibility with existing microelectronic fabrication techniques.

Detection of oxygen concentrations at ambient temperature and pressure via the devices, systems and methods herein is a substantial improvement over previous attempts to form nanoelectronic sensors for O₂, which, as described above, have required vacuum conditions and high temperature. The nanoelectronic sensing systems described herein can readily be incorporated into, for example, low power, micro-electronic devices having uses in a broad range of applications in civilian and/or military arenas (for example, in wearable personal safety devices and ambient O₂ sensors for enclosed environments such as aircraft, submarines, mines or spacecraft). Other applications for the nanoelectronic sensing systems described herein include clinical breath monitoring (breath-by-breath oximetry), providing a practical and low-cost biodiagnostic tool. For such an application and other applications, the small size, light weight, and low power requirements of the sensors and sensing systems described herein provide significant advantages (for example, for incorporation into a wearable mask).

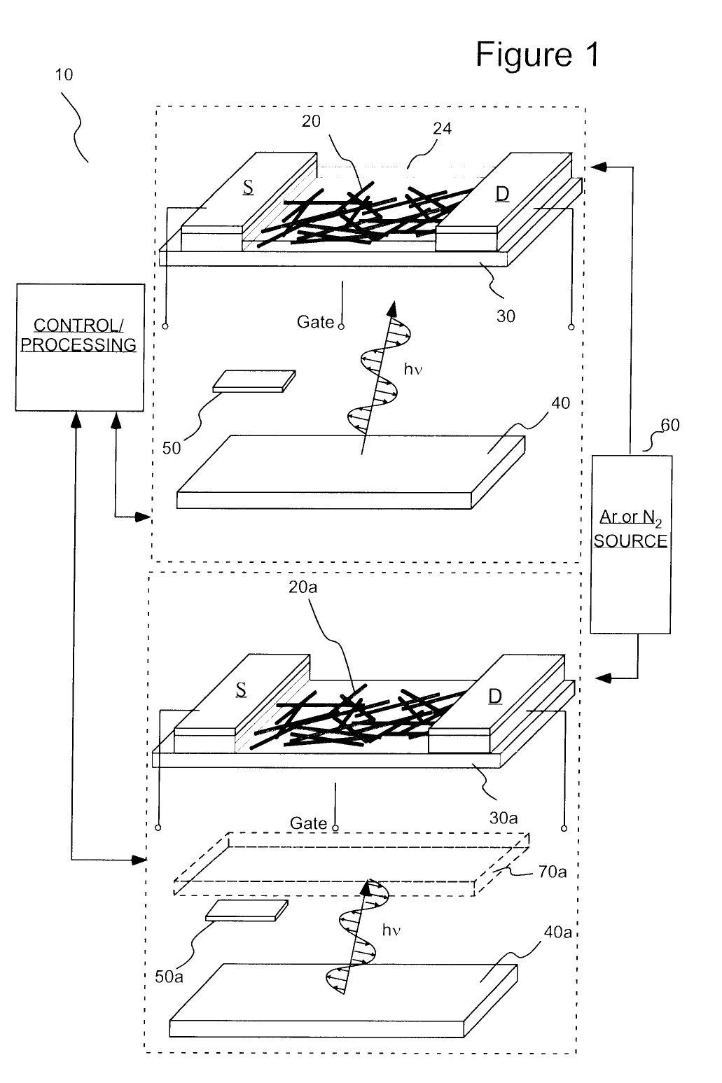

A schematic representation of sensor system 10 of the present invention is set forth in FIG. 1. As described above, the illustrated sensor system includes one or more representative nanostructures including, for example, single-wall carbon nanotubes or SWNTs (for example, a network of SWNTs). As clear to those skilled in the art, various other nanostructures are suitable for use in the present invention. Such nanostructures include, for example, multiple-wall nanotubes, nanowires, nanofibers, nanorods, nanospheres, or the like, or mixtures of such nanostructures. Moreover, in addition to carbon, those skilled in the art will appreciate that the nanostructures of the present invention can be formed of boron, boron nitride, and carbon boron nitride, silicon, germanium, gallium nitride, zinc oxide, indium phosphide, molybdenum disulphide, silver, and/or other suitable materials.

A semiconducting SWNT or network of SWNTs 20 (or other nanostructures) can, for example, be disposed upon a substrate 30 (for example, quartz) and contacted by two conductive (for example, metallic such as Au and/or Ti) electrodes representing a source (S) and a drain (D). In several studied representative embodiments, a photoactive layer 24 of a lanthanide-containing dendrimer molecule (Eu₈) formed with a derivative of a PAMAM dendrimer that incorporated 1,8-naphthalimide groups and lanthanide (Eu) cations (as described above) was coated upon the SWNT network 20.

In single-walled carbon nanotubes, all carbon atoms are located on the surface where current flows, making a stable conduction channel that is extremely sensitive to a surrounding chemical environment. Nanotubes, including SWNT's, have the ability to change conductance in response to interaction with (for example, absorption of) different gases. This characteristic is, for example, implemented in system 10. Support 30 can, for example, be an optically transparent, insulating layer of quartz in a FET-configured or chemiresistor circuit.

In the embodiment illustrated, energy is transmitted through the optically transparent quartz support from an energy source 40. Energy can alternatively be transmitted to chromophore-containing polymeric (or other photoactive) layer 24 directly (from above, in the orientation of FIG. 1), enabling the fabrication of microelectronic chemiresistor or field effect transistors (FETs) devices on opaque supports such as SiO₂ for chemiresistors or Si/SiO₂ for FETs. While the electrical measurements (via, for example, a control/processing system) are insensitive to the transparency of substrate 40, use of an opaque substrate limits optical measurements to emission (for example, luminescence) spectroscopy. A transparent substrate is, for example, suitable for absorbance spectroscopy. In the illustrated embodiment, an optical sensor 50 is illustrates schematically.

Measurements made with devices or systems including random networks of SWNTs can be advantageous because random network devices are less prone to failure as a result of the large number of conduction pathways. Additionally, while random network devices may not provide information on individual nanotube response, as with singly isolated SWNT FETs, they possess an intrinsic averaging effect in that they remove nanotube-to-nanotube variation as a result of the combined response of the entire network. As an analyte comes into contact with the device surface, SWNT conductance is modified to produce a detection signal.

The sensors or sensor systems studied herein exhibit limited sensitivity to NO₂. However, the inherent sensitivity of the SWNT network to low concentrations of NO₂ provides an internal standard against false measurement—ultimately providing an advantage over current solid-state platforms. Moreover, the insensitivity of the sensors or sensor systems to CO₂ illustrates potential of the molecular system as a component in sensor array architectures for monitoring O₂ levels in ambient atmospheres.

The representative polymer-chromophore/nanostructure systems described herein (with or without lanthanide complexing) can be deposited on many different types of surfaces or substrates, allowing flexible design and addressing the requirements of a broad range of applications. Various polymer surfaces can, for example, be both flexible and transparent. Example of flexible, translucent polymers suitable for use as substrates include polyimide (PI) and polyethylene terephthalate (PET). Small size, light weight, low power, room temperature operation, bimodal (spectroscopic and electronic) operation modes, oxygen selectivity, versatile design, can be adapted to different types and formats of supports.

As described above, in several representative embodiments, the sensors or sensor systems include a combination of SWNT and a lanthanide-containing dendrimer molecule (Eu₈) formed with a derivative of a PAMAM dendrimer that incorporate 1,8-naphthalimide groups and lanthanide (Eu) cations. Such representative embodiments and studies thereof are described in further detail below. The studied representative examples of SWNT-Eu₈ systems exhibited bimodal (optical spectroscopic and electrical conductance) sensitivity to molecular O₂ at room temperature and ambient pressure as described above. Using representative SWNT-Eu₈ based chemiresistors, linear and reversible electronic response to environmentally relevant O₂ concentrations (varying, for example, between 5-27%) were demonstrated without the use of vacuum instrumentation or high temperatures.

It has been hypothesized that SWNTs donate electronic density into the photodepleted ground state of an overlying chromophore during illumination with light. Without limitation to any mechanism, the observed combined electrical and steady state spectroscopic behavior of the Eu₈-SWNT devices hereof fits such hypothesis, wherein the increased device conductance, and decreased SWNT S₁₁ band absorbance during 365 nm illumination suggests that the photodepleted ground state of the Eu₈ complex exerted an attraction towards SWNT valence band electrons during illumination with 365 nm light.

The sustained Eu₈-SWNT photogenerated “ON-state conductance” after illumination with 365 nm light resembles the behavior of optoelectronic memory devices composed of polymer-decorated SWNTs. In such systems, a so-called metastable ON-state persists after photoexcitation through the excitonic (separated electron-hole pairs) filling of electron traps at the SiO₂ surface. SiO₂ electron traps include SiOH groups, water molecules hydrogen bonded to the device surface, and a variety of other defects. The abrupt increase in the network conductance immediately following termination of UV light has recently been described as a characteristic of photo-induced exciton separation and charge trap filling in polymer-decorated SWNT devices. Moreover, the observation of a slight decay in the photogenerated ON-state conductance of the Eu₈-decorated SWNT networks is a consequence of the gradual recombination of spatially separated excitons.

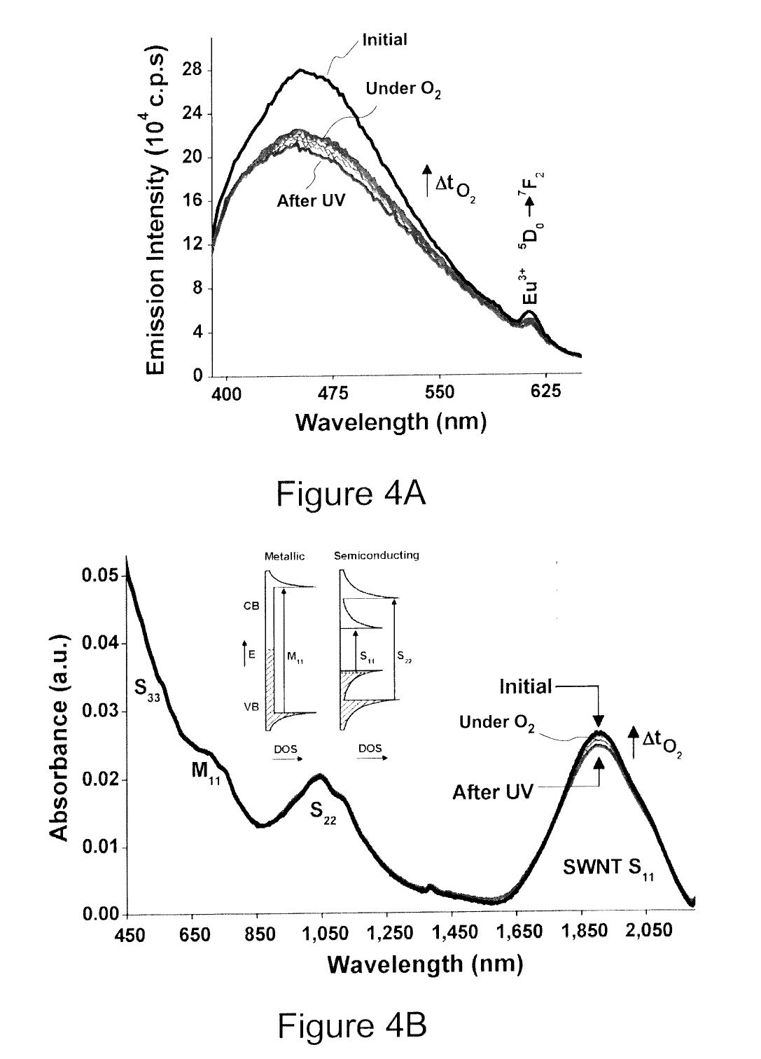

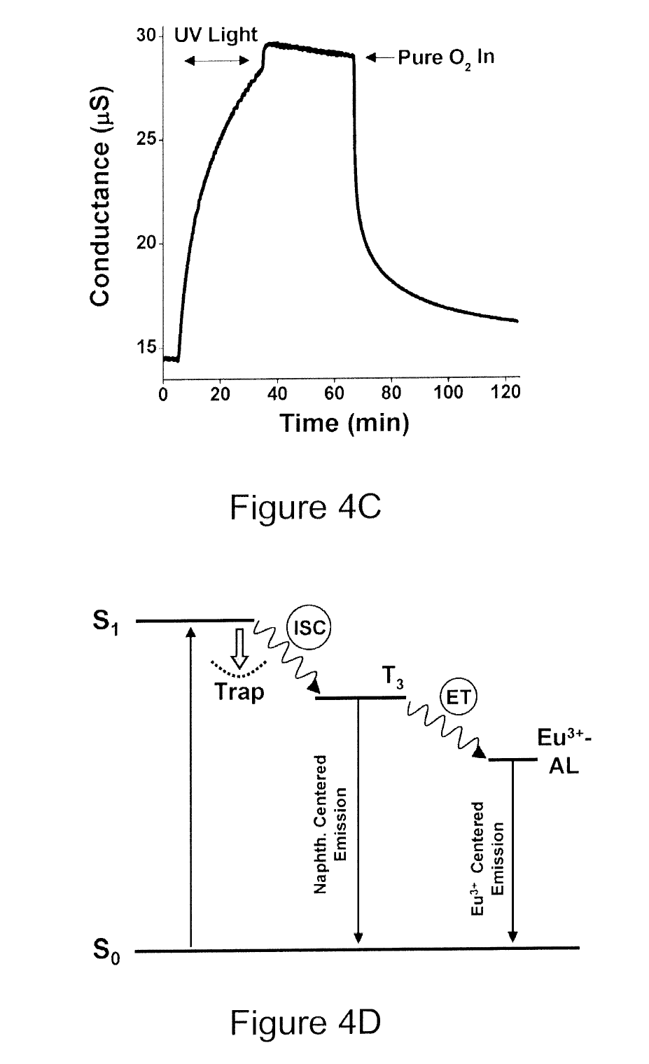

In contrast to polymer-decorated SWNT optoelectronic devices, which typically require an externally applied gate voltage to restore the initial conductance under ambient conditions, the photogenerated ON-state of the studied representative Eu₈-SWNT system was sensitive towards O₂. Without limitation to any mechanism, a model based on the relative energy levels of the Eu₈ electronic states, and electron traps in the quartz substrate, is described in FIG. 4D. For example, 365 nm illumination desorbs O₂ from the device surface while photoexciting electronic density from the ground singlet state (S₀) of the Eu₈ complex into an excited singlet state (S₁), resulting in energy transfer to the electron traps at the quartz surface.

After illumination, a comparable decrease was observed in both the naphthalimide photoactive moiety and in the Eu³⁺ centered emission bands, while the lifetime of the T₃ state was not strongly affected. This observation suggests that the electron traps are located close in energy to the S₁ state of the Eu₈ complex. In this configuration, the traps can accept energy from the S₁ state (block arrow) and inhibit intersystem crossing (ISC) into the T₃ state, thereby acting as an electronic bottleneck. The trap-induced inhibition of ISC serves to decrease the electronic population in both the T₃ and Eu³⁺-AL, producing the observed decrease in emission intensities. Subsequently, a Coulomb attraction develops between the photo-depleted S₀ state and electrons in the SWNT valence band, which effectively p-dopes the SWNT valence band. This phenomenon produces the increased Eu₈-SWNT network conductance during UV-illumination, sustained metastable ON-state conductance after the termination of UV-illumination, and decreased absorbance in the SWNT S₁₁ band.

O₂ passivates quartz charge traps, such as SiOH, through the introduction of non-radiative relaxation pathways. Consequently, and without limitation to any mechanism, it is proposed that the introduction of O₂ results in adsorption on the device surface and passivation of the electron traps through the addition of non-radiative pathways. The adsorption of O₂ removes the electron bottleneck, increases ISC, and leads to the restoration of both the naphthalimide and Eu³⁺ centered emission band intensities. The increased lifetime of the Eu³⁺ centered transition after 365 nm illumination is a consequence of O₂ desorption, which removes any O₂-induced non-radiative pathways in the Eu³⁺ electronic structure. Finally, exciton recombination in the naphthalimide S₀ state eliminates the Coulombic attraction between the Eu₈ ground state holes and SWNT valence band electrons, which decreases the Eu₈-SWNT network conductance and increases the absorption of the SWNT S₁₁ band O₂ exposure.

To summarize the proposed response mechanism (FIG. 4D), once again, without limitation to any particular mechanism, photoexcitation of the Eu₈-SWNT system promotes Eu₈ ground state electrons into an excited state, which subsequently fill electron traps at the quartz substrate surface. This leads to a Coulombic attraction between SWNT valence band electrons and the depleted Eu₈ ground state orbital, effectively p-doping the SWNT valence. Upon the introduction of O₂ gas, non-radiative relaxation pathways allow electrons to return from the quartz electron traps back into the Eu₈ ground state. This alleviates the Coulombic attraction between the SWNT valence band and Eu₈ ground state and reverses the SWNT p-doping.

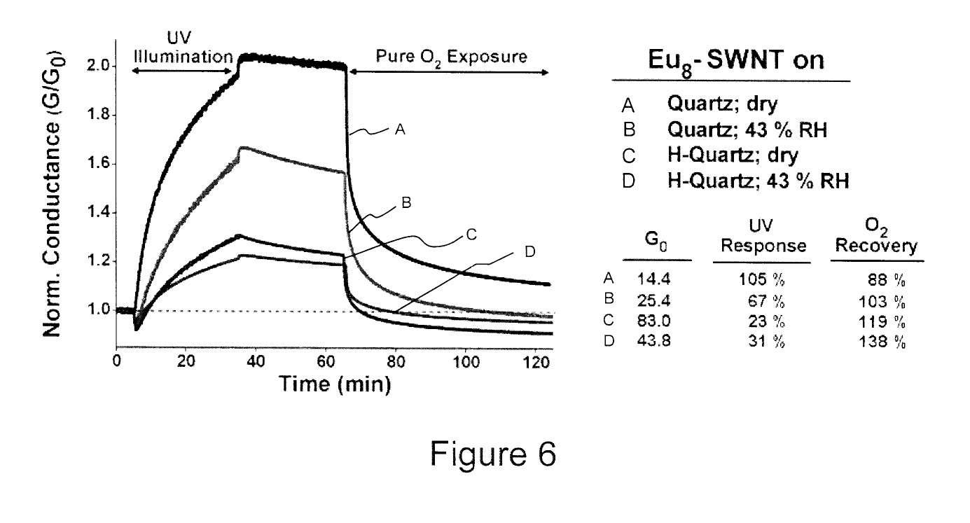

In several studies, the quartz surface was modified to study how an intentional increase in the number of surface electron traps (SiOH groups and H₂O) would affect the Eu₈-SWNT sensitivity to UV light and O₂ exposure in atmospheres of 0% and 43% relative humidity. The studies indicated that devices with increased trap sites behaved in a qualitatively similar manner, but the response to an hour-long exposure to O₂ was consistently greater than 100% (see FIG. 6). This phenomenon was more pronounced in atmospheres with 43% relative humidity, indicating that the density of charge traps has an influence on device behavior in the presence O₂.

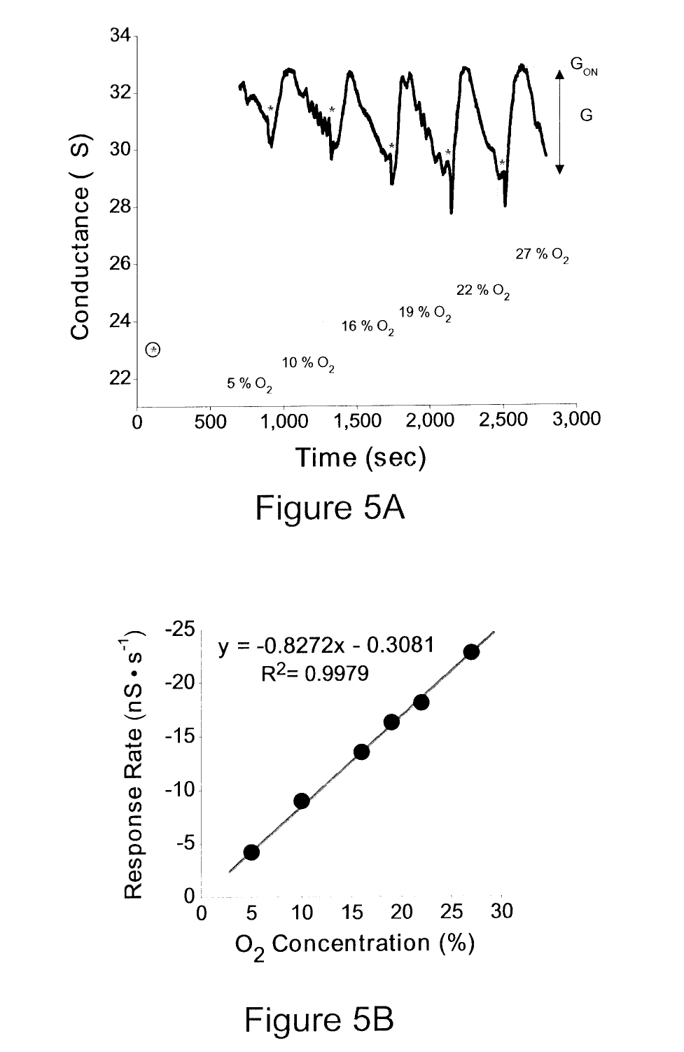

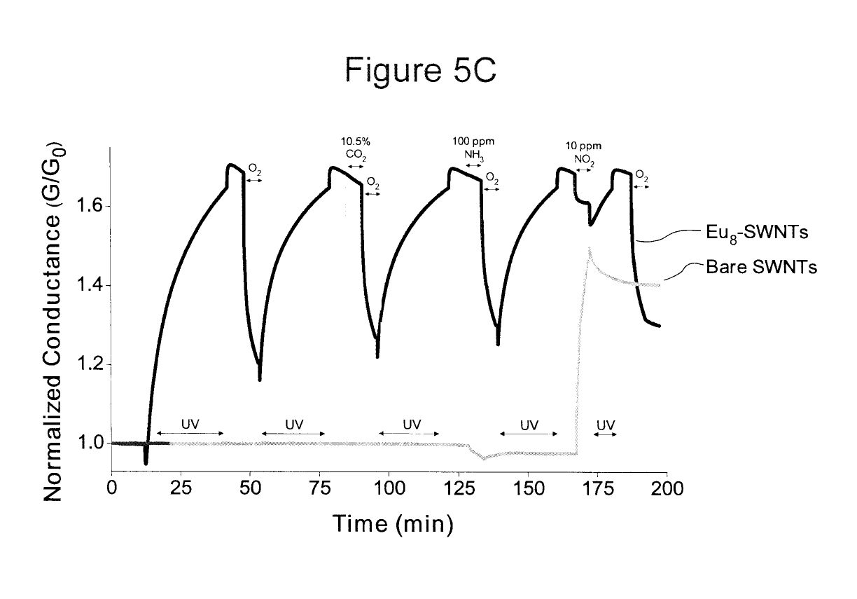

Using the Eu₈-SWNT devices in a chemiresistor configuration as illustrated in FIG. 1, a linear electrical response to O₂ in the concentration range tested (5-27%) was observed. By exploiting the stability of the Eu₈-SWNT photogenerated ON-state conductance, a baseline was created for measuring O₂ response. For example, an initial 365 nm illumination in dry Ar (marked with an encircled asterisk in FIG. 5A) established a baseline at an arbitrary network conductance (G_{ON}). Sequential pulses of dry O₂ gas (diluted in Ar) produced a concentration dependent decrease in the network conductance (FIG. 5A). O₂ exposure (indicated with dashed lines) was followed by short periods of 365 nm illumination (marked with asterisks) to return the device to its arbitrarily defined ON-state conductance.

During the 200 second O₂ exposure periods the device response did not saturate, however the rate of change in the network conductance scaled with the concentration of O₂. FIG. 5B plots the rate of conductance change (ΔG relative to G_{ON}) during O₂ exposure cycles. Based on the standard deviation in the ON-state conductance before the first O₂ exposure, the signal to noise ratio was calculated to be 3.89 for the device response to 5% O₂. The linear response to O₂, and repeated return to the ON-state conductance, indicates that the Eu₈-SWNT network did not experience photo-degradation or chemical damage during operation. Using a value of three times the standard deviation of the ON-state conductance as the minimum detection limit (MDL), it was determined that the MDL of the system is approximately 0.4% O₂ for a 200 second exposure time, which is comparable with state of the art, high temperature metal-oxide semiconductor sensor platforms. The studied systems were not optimized. Lower MDLs can, for example, be obtained.

The representative Eu₈-SWNT systems showed comparable photoresponse with N₂ as the carrier gas and demonstrated insignificant response to CO₂ and NH₃. The systems were not adversely affected by relative humidity (0-43% RH), and retained good O₂ sensitivity even after storing the device in ambient conditions one week after the initial measurement. As common with many solid-state O₂ sensors, sensitivity towards NO₂ was observed. To identify false positives resulting from the presence of oxidizing species, system 10 included both a Eu₈-SWNT network 20 and a bare SWNT network 20a immobilized upon a quarts support 30a (see FIG. 1 and the studies of FIG. 5C). Because bare SWNTs respond to oxidizing gases, such as NO₂, but do not respond to O₂, this system design provides an internal reference against the measurement of false positives. By monitoring the simultaneous conductance of both networks during UV, O₂ and NO₂ exposure, one can determine the difference between a true O₂ response, and a false response resulting from the presence of NO₂. As illustrated in FIG. 1, bare SNWT network 20a can be masked via a mask 70a to eliminate illumination with UV light. FIG. 1 illustrates an embodiment in which decorated SNWT network 20 and bare (undecorated) SNWT network 20a are immobilized on separate substrates 30 and 30a, respectively. Alternatively, the two layers can be immobilized upon a common substrate. The sensitivity of system 10 to NO₂ indicates that system 10 can also be incorporated in an NOₓ sensor system.

The insignificant sensitivity of system 10 towards CO₂ and NH₃, the identifiable response to an oxidizing species (NO₂), and the comparable operation in N₂ and humid atmospheres indicate that system 20 provides a low-temperature platform for monitoring O₂ levels under ambient conditions. In the design of a field platform, a small reservoir 60 of inert gas such as, for example, N₂ or Ar can be provided to purge the sample chamber during illumination with energy source 40 which can, for example, be a compact UV light source. Systems of the present invention can, for example, be used to measure the concentration of a gas analyte in a liquid by use of a gas permeable membrane between the liquid and the decorated nano structures.

### Experimental

1. Synthesis of G3-PAMAM-(1,8-naphthalimide). Poly(amidoamine) (PAMAM) dendrimer G(3)-NH₂ (390.5 mg, 0.0565 mmol) and 1,8-naphthalic anhydride (447.9 mg, 2.26 mmol) were suspended in DMF (25.0 mL) and stirred at 95° C. for 48 hours under a nitrogen atmosphere. The compound was purified by dialysis using a regenerated cellulose membrane (Fisher; nominal MWCO 12,000-14,000) in DMSO for three days. The solution in the dialysis membrane was dried in a vacuum oven to yield the title product as a brown solid (517.6 mg, 72.4%); ¹H NMR (300 MHz; CDCl₃, δ): 8.23 (br s, 64H, Ar H), 7.97 (br s, 64H, Ar H), 7.69 (m, 60H, —NH), 7.49 (br s, 64H, Ar H), 4.12 (br s, 64H, —N(CO)₂CH₂—), 3.51 (br s, 64H, —NHCH₂—), 3.19 (m, 56H, —NHCH₂—), 2.90-2.40 (m, 60H, —NCH₂CH₂NH—), 2.27 (m, 120H, —NCH₂CH₂CO—), 1.93 (m, 120H, —COCH₂—).

2. Synthesis of Eu₈-G3-PAMAM-(1,8-naphthalimide), Eu₈. The preparation of the dendrimer complex was adapted from a synthesis protocol that described previously for a parent dendrimer ligand. Cross, J. P., Lauz, M, Badger, P. D & Petoud, S. Polymetallic lanthanide complexes with PAMAM-naphthalimide dendritic ligands: luminescent lanthanide complexes formed in solution. J. Am. Chem. Soc. 126, 16278-16279 (2004). G3-PAMAM-(1,8-naphthalimide)₃₂ (16.81 mg, 1.326×10⁻⁶ mol) was dissolved in DMSO (5.0 mL) and a solution containing 1.397 mM of Eu(NO₃)₃ solution in DMSO (7.593 mL, 1.061×10⁻⁵ mol) was added. The mixture was incubated for seven days. DMSO was then evaporated in a vacuum oven, and the residual solid was dissolved in 10.0 mL of DMF to obtain 1.40×10⁻⁴ M solution.

3. SWNT Device Fabrication. Optically transparent and electrically conductive SWNT network devices were fabricated and measured as previously described in Kauffman, D. R. & Star, A. Simultaneous spectroscopic and solid-state electronic measurement of single-walled carbon nanotube devices. J. Phys. Chem. C 112, 4430-4434 (2008). Briefly, commercially available SWNTs (available from Carbon Solutions, Inc. or Riverside, California: P2 SWNTs; reported purity 70-90 percent) were suspended in DMF via sonication without further purification. 1 in²× 1/16^{th} in thick fused quartz (SiO₂) plates (available from Quartz Scientific of Fairport Harbor, Ohio; reported specific resistance of 10×10¹⁸ Ohm/cm³ at 20° C.) served as substrates 30, and were cleaned prior to SWNT deposition with acetone, rinsed with water and dried under compressed air. After spraycasting the SWNT networks with a commercial air brush (Iwata) onto the heated quartz plates, Al tape and Ag paint were used to form the device electrodes. To create devices with two SWNT networks a cotton tipped applicator soaked in acetone was used to wipe clean a section of the spray-cast SWNT network. Two devices were created from the bisected SWNT network by individually connecting electrodes to each section with Al tape and Ag paint. Quartz plates with additional hydroxyl surface groups were created by soaking overnight in a 3:1 solution of concentrated H₂SO₄ and 30% H₂O₂ (piranha solution). Nanotube field-effect transistor (NTFET) devices consisted of interdigitated Au electrodes (10 μm pitch size) on a Si/SiO₂ substrate; dilute suspensions of Carbon Solutions P2 SWNTs in DMF were dropcast onto heated devices to form the conduction channel.

4. Device Decoration and Measurement. SWNT devices were decorated as follows: the devices were heated to just above the solvent boiling temperature and 200 μL (4 μL for NTFETs) of a particular molecule was dropcast evenly onto the surface of the device. For NTFET devices, all measurements were conducted in ambient conditions with a drain-source bias voltage of 100 mV with two Keithley model 2400 SOURCEMETER® text instruments, available from Keithley Instruments, Inc. of Cleveland, Ohio, interfaced to LABVIEW® software available from National Instruments of Austin, Tex.

UV-vis-NIR absorption spectra were recorded with a Perkin Elmer Lambda 900 UV-vis-NIR spectrophotometer, and steady-state excitation and emission spectra, as well as the luminescence lifetime measurements were recorded using a custom designed JY Horiba Fluorolog-322 spectrofluorimeter and a Tektronix TDS model 754D oscilloscope. At least 1000 luminescence decay traces, each containing 50,000 points were average and treated to calculate the lifetimes ORIGIN® 7.0 software available from Originlab Corporation of Northampton, Mass. The reported lifetime for a particular excited state is the average of at least two independent measurements. For multi-exponential fittings, the amplitude of the major component was used as a criteria for isolating the values reported in Table 1; components with amplitudes less than 1% were discarded. The Eu³⁺-AL lifetimes were deconvoluted by subtracting the component from the triplet state (T₃) lifetime. Time-resolved excitation and emission spectra of the Eu₈ solutions were measured using a Varian Cary Eclipse spectrofluorimeter.

For the optically transparent SWNT devices, the UV-exposure and gas sensitivity measurements were performed in a custom built gas delivery chamber as described in Kauffman, D. R. & Star, A. Simultaneous spectroscopic and solid-state electronic measurement of single-walled carbon nanotube devices. J. Phys. Chem. C 112, 4430-4434 (2008) that was housed inside of the spectrometers for simultaneous electrical and optical measurements; the device conductance was measured at a bias voltage of 500 mV with a Keithley model 2400 SOURECEMETER interfaced to LABVIEW 7.1 software. The network conductance of two devices on a single quartz substrate was simultaneously measured at 500 mV with a Keithley 2602 SOURCEMETER and a Keithley 708A switching matrix using Zephyr data acquisition software. The atmosphere inside the chamber was controlled with flowing research grade gases at a constant flow rate of 1000 standard cubic centimeters per minute (SCCM); all gases were dry unless otherwise noted. Atmospheres of 43% RH were created by passing the gases over the headspace of sealed container of saturated K₂CO₃ solution; literature RH: 43.2±0.3% at 20° C. The UV lamp used for device illumination was a UVP, Inc. Model UVGL-55 hand held unit (365 nm; 250 μW/cm²). All measurements were conducted at room temperature and ambient pressure. Scanning electron microscopy (SEM) and energy dispersive X-ray spectroscopy (EDX) were conducted on a Phillips XL30 FEG microscope operated at an accelerating voltage of 10 kV; samples were sputter coated with Pd prior to imaging to prevent charging of the insulating quartz substrate.

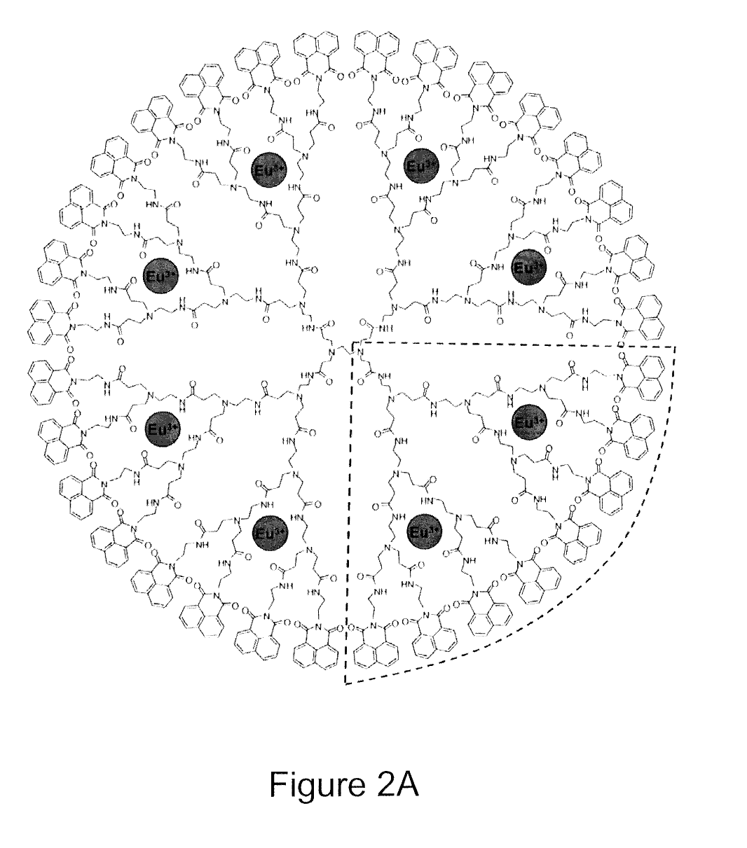

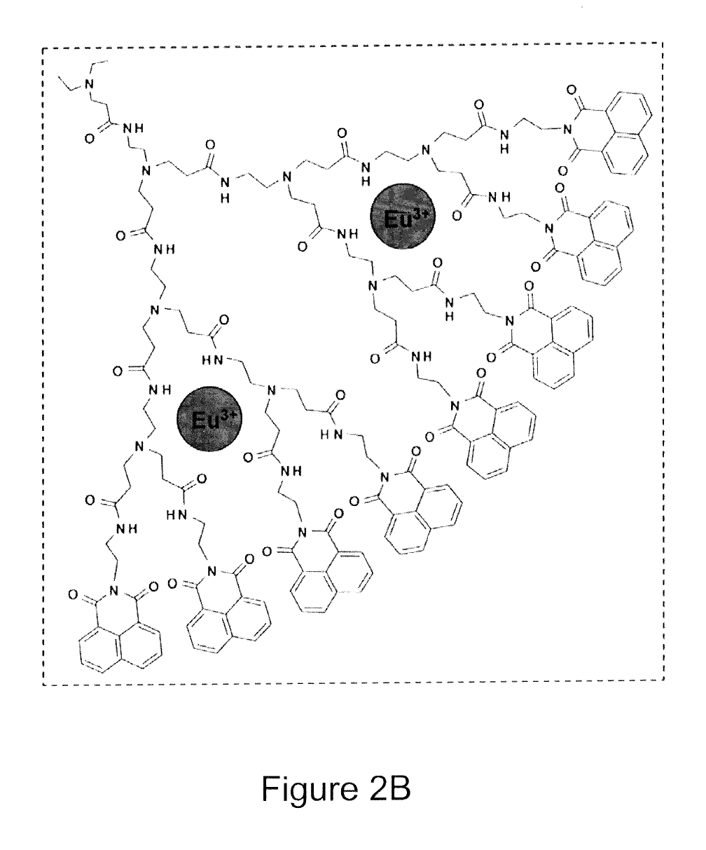

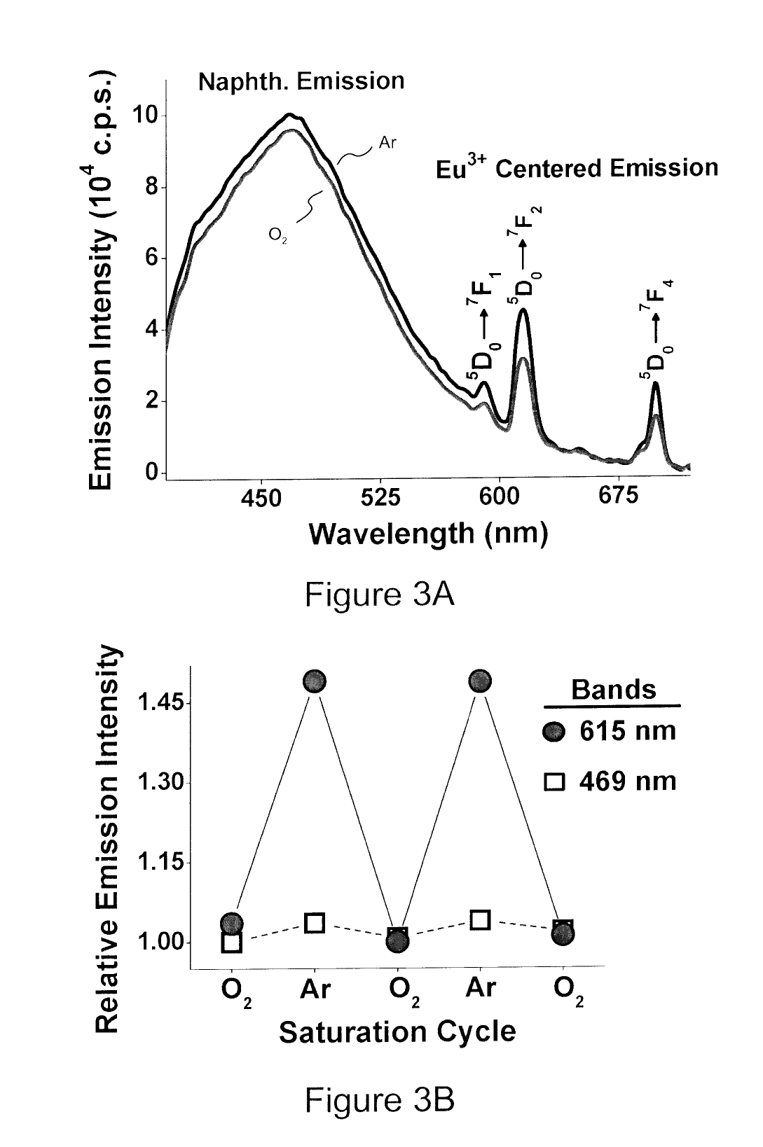

5. Solution Phase Behavior of Eu₈. FIG. 3A presents the emission spectra of a Eu₈ solution (in DMF) saturated with either Ar or O₂, where O₂ saturation results in a decrease of the apparent emission intensity. The Eu₈ emission profile contains a broad band arising from the excited states of 1,8-naphthalimide groups centered around 469 nm, and three narrow emission bands located at lower energy that are characteristics of the Eu³⁺ centered transitions. In the Eu₈ structure, the 1,8-naphthalimide groups act as sensitizing agents. Specifically, photoexcited electrons in the excited naphthalimide singlet state undergo intersystem crossing into a triplet state, and subsequent energy transfer into the accepting levels of the Eu³⁺ ions produces the sharp Eu³⁺ centered emission bands. The reversible and reproducible quenching effect of O₂ on the solution phase Eu₈ emission intensity is in accordance with its predicted behavior. However, we find that the Eu³⁺ centered emission bands show a larger sensitivity to O₂ in comparison to the 1,8-naphthalimide band. For example, FIG. 2B shows the relative emission intensity of the naphthalimide centered (469 nm; square labels) and Eu^{3+ 5}D₀→⁷F₂ (615 nm; circular labels) bands in a solution cycled several times between O₂ and Ar saturation. The larger relative change in the Eu³⁺ emission suggests that O₂ more effectively deactivates the Eu³⁺ excited state, as compared to the 1,8-naphthalimide, through the introduction of non-radiative pathways.

6. Solid-State Behavior of Eu₈. The relative emission intensity of solid-state Eu₈ (dropcast onto a quartz substrate) was constant when cycled between atmospheres of pure O₂ and Ar, highlighting a fundamental difference between the behavior of solid-state and solution phase samples. However, after illuminating the sample with 365 nm light for 30 minutes (in flowing Ar), the emission profile of the solid-state Eu₈ developed a sensitivity towards O₂, in which the intensity was decreased after illumination and partially restored under flowing O₂. The observed behavior is interesting compared to the solution phase behavior of Eu₈, and to the solid-state behavior of other O₂ sensitive photoluminescent complexes. To further explore the solid-state behavior of Eu₈, solutions were dropcast onto optically transparent and electrically conductive SWNT devices as described in Kauffman, D. R. & Star, A. Simultaneous spectroscopic and solid-state electronic measurement of single-walled carbon nanotube devices. J. Phys. Chem. C 112, 4430-4434 (2008).

Minimal changes were observed in the spectroscopic signatures of both the SWNT network and the overlying Eu₈ layer after the devices were decorated, and separate field-effect transistor measurements of Eu₈ decorated SWNT networks suggest that the dominant effect of the overlying Eu₈ layer was to introduce charge scattering sites along the SWNT network. FIG. 4A sets forth the emission spectra of a Eu₈-decorated SWNT (Eu₈-SWNT) device before and after exposure to 365 nm light, and during exposure to pure O₂. After 30 minutes of illumination with 365 nm light (in flowing Ar) the Eu₈-SWNT device experienced a 25% decrease in the emission intensity of the naphthalimide band, and a 20% decrease in the emission intensity of the Eu³⁺ centered band. The spectroscopic behavior of Eu₈ after illumination and O₂ exposure was comparable on quartz and the SWNT networks (as shown in FIG. 4A), which suggests that the observed behavior is an intrinsic property of solid-state Eu₈ on quartz.

7. Behavior of Eu₈ Decorated SWNT Networks. Using simultaneous UV-vis-NIR absorbance spectroscopy and network conductance measurements on Eu₈-SWNT devices, the underlying SWNT network was able to transduce changes in the electronic structure of the Eu₈ layer during illumination with 365 nm light and exposure to pure O₂ gas. After a 30 minute illumination period the device experienced a decrease in the first semiconducting SWNT absorption band, labeled S₁₁ in FIG. 4B. Additionally, illumination triggered an increase in the network conductance (FIG. 4C), which was termed the “photogenerated ON-state”. The ON-state conductance abruptly increased after the termination of UV light and then slowly decayed as a function of time. To test the reproducibility of the Eu₈-SWNT response to UV light, nine individual devices were exposed to 365 nm light for 30 minutes. Each device behaved qualitatively similar, but the magnitude of the response scaled inversely with the initial device conductance. This behavior differs substantially from the response of undecorated SWNTs to UV light, which show a decrease in the SWNT network conductance and an increase in the S₁₁ absorption band.

After a 30 minute exposure to 365 nm light, the device conductance decreased rapidly in the presence of O₂ such that nine individually tested devices experienced a 60±10% decrease after a 200 second exposure to pure flowing O₂, regardless of the initial network conductance. After an hour long exposure to pure O₂, nearly 100% restoration of the S₁₁ band absorbance and approximately 90% recovery of the initial device conductance was observe. This electrical behavior was also reproducible, but after 1 hour of O₂ exposure, some devices demonstrated a larger than 100% response that possibly stemmed from increased defect sites in the quartz substrate. The absorbance change of the SWNT S₁₁ band displayed a time dependency like that of the network conductance during O₂ exposure, which indicates that the device response stems from perturbations in the electronic density of the SWNT valence band rather than a modification of the potential barriers at the interface between the SWNT network and device electrodes. Throughout these experiments, the intensity of the M₁₁ transition remained constant. While the metallic component of the SWNT network may contribute to the electrical response of the SWNT devices, the finite Fermi-level electron density of metallic SWNTs (inset in FIG. 4B) renders the M₁₁ transition intensity somewhat unaffected by changes in the local charge environment.

8. Luminescence Lifetimes. The presence of the Eu³⁺ ions in the Eu₈-SWNT networks allowed a quantitative comparison between the luminescence lifetimes of the Eu₈ triplet state and the Eu³⁺ acceptor level (abbreviated as T₃ and Eu³⁺-AL, respectively). In essence, the presence of the Eu³⁺ emission serve as a spectroscopic beacon that can help identify the electronic processes that occur in the Eu₈-SWNT system by analyzing the two states' luminescence lifetimes. The luminescence lifetimes of the Eu₈ T₃ and Eu³⁺-AL were measured before and after illumination with 365 nm light (in flowing Ar), and after the reintroduction of pure O₂ gas. The data presented in Table 1 shows that the luminescence lifetime of the T₃ state was not strongly affected by 365 nm illumination or the presence of O₂. However, an increase in the lifetime of the Eu³⁺-AL after 365 nm illumination, was observed which began to decrease towards its initial value after 1 hour of O₂ exposure.

TABLE 1
Luminescence lifetimes (τ) of the Eu₈ triplet state (T₃)
and Eu³⁺ acceptor level (Eu³⁺-AL).
Measured Luminescence Lifetimes (ms)

| | T₃ | Eu³⁺-AL |
|---|---|---|
| Initial | 0.3900 (±0.0001) | 0.657 (±0.001) |
| After UV | 0.370 (±0.001) | 2.73 (±0.07) |
| After O₂ | 0.4000 (±0.0002) | 1.76 (±0.07) |

Quartz contains defects such as SiOH groups, among others, on the surface that can act as electron traps. These functionalities were confirmed spectroscopically. Soaking quartz in a 3:1 solution of concentrated H₂SO₄ and 30% H₂O₂ at room temperature further hyrdroxylates the surface (H-quartz), and produces a larger number of SiOH functionalities. This treatment renders the quartz surface more hydrophilic, because additional water molecules can hydrogen bond to the surface. FIG. 6 displays the relative response of Eu₈-SWNT networks to 365 nm light and O₂ on quartz in a dry environment and in 43% relative humidity, as well as on H-quartz in a dry environment and in 43% RH. Humidity was controlled by passing the gas over the headspace of sealed container of saturated K₂CO₃ solution (RH: 43.2±0.3% at 20° C.).

The foregoing description and accompanying drawings set forth embodiments at the present time. Various modifications, additions and alternative designs will, of course, become apparent to those skilled in the art in light of the foregoing teachings without departing from the scope hereof, which is indicated by the following claims rather than by the foregoing description. All changes and variations that fall within the meaning and range of equivalency of the claims are to be embraced within their scope.

What is claimed is:

1. A method of detecting an analyte in an environment, comprising:
immobilizing at least one photoactive composition on nanostructures, the photoactive composition exhibiting emission that is sensitive to the analyte;
applying electromagnetic radiation to the immobilized photoactive moiety for a period of time;
measuring at least one response; and
using the measured response to determine the presence the analyte in the environment.

2. The method of claim 1 wherein the nanostructures comprise carbon nanostructures.

3. The method of claim 1 wherein the analyte is oxygen.

4. The method of claim 1 wherein the measured response is at least one of a spectroscopic change or an electrical property change.

5. The method of claim 1 wherein each of a spectroscopic change and an electrical property change are measured.

6. The method of claim 3 wherein a change in at least one electrical property of the nanostructures is measured.

7. The method of claim 1 wherein the photoactive composition comprises at least one photoactive moiety selected from the group of a naphthalimide, a derivative of a naphthalimide. tropolonate, a derivative of tropolonate, perylene, a derivative of perylene, salophen, a derivative of salophen, anthraquinone, a derivative of anthraquinone, fluorene, a derivative of fluorene, benzimidazole a derivative of benzimidazole, benzimidazole-pyridine, a derivative of benzimidazole-pyridine, salicylamide, derivative of salicylamide, 2-hydroxyisophthalimidem, a derivative of 2-hydroxyisophthalimidem, beta-diketone, a derivative of beta-diketone, pyridine, a derivative of pyridine, bipyridine, a derivative of bypyridine, terpyridine, a derivative of terpyridine, phenanthridine, a derivative of phenanthridine, quinoline. a derivatives of quinoline, a phenol, a derivative of a phenol, and bis(oxazolinyl)pyridine, a derivative of bis(oxazolinyl)pyridine.

8. The method of claim 1 wherein the photoactive composition comprises at least one of a lanthanide cation chelated with a photoactive ligand, a transition metal complex, a conjugated polymers, or photoactive inorganic nanoparticles.

9. The method of claim 8 wherein the lanthanide cation is a cation of Lanthanum (La), Cerium (Ce), Praseodymium (Pr), Neodymium (Nd), Promethium (Pm), Samarium (Sm), Europium (Eu), Gadolinium (Gd), Terbium (Tb), Dysprosium (Dy), Holmium (Ho), Erbium (Er), Thulium, (TM), Ytterbium (Yb), or Lutetium (Lu).

10. The method of claim 6 wherein the photoactive composition comprises at least one photoactive moiety selected from the group of a naphthalimide. a derivative of a naphthalimide. tropolonate, a derivative of tropolonate, perylene, a derivative of perylene, salophen, a derivative of salophen, anthraquinone, a derivative of anthraquinone, fluorene, a derivative of fluorene, benzimidazole a derivative of benzimidazole, benzimidazole-pyridine, a derivative of benzimidazole-pyridine, salicylamide, derivative of salicylamide, 2-hydroxyisophthalimidem, a derivative of 2-hydroxyisophthalimidem, beta-diketone, a derivative of beta-diketone, pyridine, a derivative of pyridine, bipyridine, a derivative of bypyridine, terpyridine, a derivative of terpyridine, phenanthridine, a derivative of phenanthridine, quinoline. a derivatives of quinoline, a phenol, a derivative of a phenol, and bis(oxazolinyl)pyridine, and a derivative of bis(oxazolinyl)pyridine.

11. The method of claim 6 wherein the photoactive composition comprises at least one of a lanthanide cation chelated with a photoactive ligand, a transition metal complex. a conjugated polymers, or photoactive inorganic nanoparticles.

12. The method of claim 12 wherein the lanthanide cation is a cation of Lanthanum (La), Cerium (Ce), Praseodymium (Pr), Neodymium (Nd), Promethium (Pm), Samarium (Sm), Europium (Eu), Gadolinium (Gd), Terbium (Tb), Dysprosium (Dy), Holmium (Ho), Erbium (Er), Thulium, (TM), Ytterbium (Yb), and Lutetium (Lu).

13. The method of claim 12 wherein the photoactive moiety is incorporated within an oligomer or a polymer.

14. The method of claim 12 wherein the photoactive moiety is incorporated within an oligomer or a polymer and wherein the oligomer or the polymer comprises oxygen donor atoms or oxygen donor groups.

15. The method of claim 1 wherein the nanostructures are supported upon a surface.

16. The method of claim 15 wherein the surface comprises SiO₂ or a polymer.

17. The method of claim 15 wherein the surface is translucent.

18. The method of claim 6 further comprising:
measuring at least one electrical property of nanostructures comprising no photoactive composition immobilized thereon in the environment to provide a reference measurement.

19. A system for detecting an analyte in an environment, comprising:
nanostructures comprising at least one photoactive composition immobilized on the nanostructures, the photoactive composition exhibiting emission that is sensitive to an analyte;
at least one energy source to apply electromagnetic radiation to the immobilized photoactive moiety for a period of time; and
at least one measurement system to measure a response, the measured response being used to determine the presence the analyte in the environment.

20. The system of claim 19 comprising at least one measurement system to measure a spectroscopic change and at least one measurement system to measure a change in an electrical property of the nanostructures.

21. The system of claim 19 comprising at least one measurement system to measure a change in an electrical property of the nanostructures.

22. A composition comprising nanostructures having immobilized thereon a photoactive composition comprising at least one photoactive moiety and at least one lanthanide cation.

23. The method of claim 22 wherein the photoactive composition comprises a lanthanide cation chelated with a photoactive ligand.

24. The method of claim 23 wherein the lanthanide cation is a cation of Lanthanum (La), Cerium (Ce), Praseodymium (Pr), Neodymium (Nd), Promethium (Pm), Samarium (Sm), Europium (Eu), Gadolinium (Gd), Terbium (Tb), Dysprosium (Dy), Holmium (Ho), Erbium (Er), Thulium, (TM), Ytterbium (Yb), or Lutetium (Lu).

25. The composition of claim 23 wherein the cation is at least one of Ln³⁺, Pr³⁺, Nd³⁺, Sm³⁺, Eu³⁺, Tb³⁺, Dy³⁺, Ho³⁺, Er³⁺, Tm³⁺ or Yb³⁺.

26. The composition of claim 25 wherein the photoactive moiety is incorporated within an oligomer or a polymer.
